(19) United States
(12) Patent Application Publication
(10) Pub. No.: US 2001/0042249 A1
(43) Pub. Date: Nov. 15, 2001

(54) System and method of joining encoded video streams for continuous play

(76) Inventors: Dan Knepper, Los Angeles, CA (US); Karl F. Reese, Inglewood, CA (US); Brian Otto, North Hollywood, CA (US)

Correspondence Address: DOUGLAS N. LARSON, ESQ., OPPENHEIMER WOLFF & DONNELLY LLP, 2029 Century Park East, Suite 3800, Los Angeles, CA, 90067, US

(21) Appl. No.: 09/782,957

(22) Filed: Feb. 12, 2001

Related U.S. Application Data
(60) Provisional application No. 60/189,398, filed on Mar. 15, 2000.

(51) Int. Cl. G06F 3/00; H04N 5/445

(52) U.S. Cl. 725/42

(57) ABSTRACT

A system and method for transferring entertainment media files and advertisement media files. A set of advertisement files is pre-cached at the client side. A show, movie or other form of entertainment object may be requested by a user, and the set of files of which that entertainment object is composed is delivered to the user over the Internet. An instruction set is downloaded from the server to the client; this set directs the client to combine the entertainment object(s) with advertisement media files selected from the pre-cached set of advertisement media files at run time. When the entertainment set is arranged and played at the client side, it will appear as a single, continuous clip that includes both entertainment and advertisement content.

### CROSS-REFERENCE TO RELATED APPLICATION

This application claims the benefit of U.S. Provisional Application No. 60/189,398, filed Mar. 15, 2000, whose entire contents are hereby incorporated by reference.

### BACKGROUND OF THE INVENTION

The invention is related to entertainment and advertisement methods as employed preferably over the Internet. More particularly, the invention is directed to systems and methods for providing seamless video entertainment with integrated targeted advertisement media files.

The Internet provides a medium in which to view and appreciate many forms of entertainment. One way to finance entertainment on the Internet is through advertisement media files. Therefore, much attention has been focussed in recent years on providing entertainment and advertising over the Internet.

A traditional approach for providing entertainment over the Internet has been the use of streaming, which is a technique for transferring data so that it can be processed by the client as a steady and continuous stream. Streaming is commonly used in the delivery and playback of media files for a variety of applications including entertainment, education and dissemination of information in general.

Although streaming allows for the playback of video and audio segments by a client-side user without the segments needing to be stored at the client-side, significant drawbacks are inherent to streaming technologies. Because streaming methods are attempts to play files on a client-side computer as the files are received from a server through an Internet connection, the speed and quality of the playback depend on a user's Internet connection. For example, a slow Internet connection results in choppy, unreliable playback of video and audio feeds.

Buffering is a technique that is used with streaming applications, wherein extra frames are stored in a client computer's cache prior to playback. This allows for a “buffer” of playback material to be ready for playback in the event that a slow Internet connection prevents immediate and continuous delivery of that material. However, only a small amount of a computer's cache reserves can be utilized for buffering, placing a limit on the amount of protection that is actually available against Internet speed inconsistencies. Furthermore, the media files that are typically utilized in streaming applications are very large, making complete download and storage of the files on a client-side computer space-prohibitive.

Therefore, a need has been felt for a new method of delivery and playback of video and/or audio media files on a client-side computer. The method should enable smooth playback of these media files, regardless of the speed or quality of a user's Internet connection.

### SUMMARY OF THE INVENTION

Accordingly, the present invention seeks to provide Internet users with a means of playing media files from the Internet without employing traditional streaming methods. The invention further seeks to provide media content providers with a directly-targeted advertisement method and control of advertisement content associated with their media. Media files are downloaded from a server to a client, and pre-cached at the client side. The media files can include both entertainment media files and advertisement media files. The media files, when arranged at the client side during playback, represent a series of show clips, or a single, continuous show, which does not have the appearance of being a multiplicity of media files.

An instruction set, which in one embodiment resides within a text file, is also downloaded from the server to the client. The text file includes tags, which act as specific instructions to the client. The tags direct the client as to how to arrange the pre-cached entertainment and advertisement media files. The multiple media files are thus assembled to form a clip immediately preceding playback, or real-time, and the clip has the appearance of being a single media file.

One of the inventions herein is a method of displaying multiple files at a client side wherein the method includes selecting multiple media files on a client side, arranging the media files on the client side, and playing the media files together to appear as a single continuous clip. The arranging and the playing may be in accordance with an instruction set at the client side. The media files may comprise at least one entertainment media file and at least one advertisement media file.

Another invention disclosed herein is an instruction set which includes instructions to a client to play a plurality of media files such that the files appear as a single continuous clip. The instruction set is preferably delivered to the client from a server in response to a user request, and the instruction set indicates the order in which the media files are to be played. Again, the media files may comprise at least one entertainment media file and at least one advertisement media file.

A further invention is an advertisement set stored at a client side which includes multiple advertisement media files that were delivered to the client side from a server. The content of the advertisement media files stored at the client side may be altered by the server. For example, advertisement media files can be added or removed from the client-side storage. And the content may be selected according to an analysis of user statistics and activity history data, for example.

A still further invention is a method of combining a plurality of clips which includes providing an instruction set that directs the assembly of multiple media files from local storage, to be played back to a user as a single continuous show without substantial interruption.

Another definition of the invention herein includes a system and method for transferring entertainment media files and advertisement media files, wherein a multiplicity of these files may be collected, assembled, and played at a client side. A set of advertisement files is pre-cached at the client side. A show, movie, or other form of entertainment object may be requested by a user, and the set of files of which that entertainment object is composed are delivered to the user over the Internet. An instruction set is also downloaded from the server to the client, which directs the client to combine the entertainment object(s) with advertisement media (or other) files selected from the pre-cached set of advertisement media files at run time. Advertisement files may be associated, either positively or negatively, with the entertainment set. Advertisement files may also be unassociated, in that they may be placed within an entertainment set at random or by some other means When the entertainment set is arranged and played at the client side, it will not be apparent to the user that the set is a combination of multiple, separate files. Rather, the appearance will be that of a single, continuous clip that includes both entertainment and advertisement content.

The foregoing and other objects, features and advantages of the present invention will be apparent from the following detailed description of the preferred embodiments taken in conjunction with the accompanying drawings.

### BRIEF DESCRIPTION OF THE DRAWINGS

FIG. 1 illustrates the top-level components of a content delivery and playback system according to one embodiment of the invention;

FIG. 2 illustrates the dynamic nature of a client-side advertisement set according to one embodiment of the invention;

FIG. 3 is a flow chart showing the steps of a method of the invention;

FIG. 4 illustrates one possible arrangement of multiple media files to be played back with the appearance of being a single media file;

FIG. 5 depicts the role of client-side application software as an interface between the server and the client;

FIG. 6 illustrates the appearance of a client-side application launched on a user's computer according to one embodiment of the invention;

FIG. 7 illustrates the events occurring between a user's request for a show and the actual playback of that show on a display device at the client side according to an embodiment of the invention; and

FIG. 8 is a flow chart illustrating an exemplary process of the present invention.

### DETAILED DESCRIPTION OF PREFERRED EMBODIMENTS OF THE INVENTION

In the following description of the preferred embodiments reference is made to the accompanying drawings which form a part thereof, and in which are shown by way of illustration of specific embodiments in which the invention may be practiced. It is to be understood that other embodiments may be utilized and structural and functional changes may be made without departing from the scope of the present invention.

For playback of the show to occur on the client, three components are used pursuant to one aspect of the invention. These are entertainment rich media files, advertisement rich media files, and an instruction set, or text file, that describes the assembly and playback order of the media files. As used herein, the terms “instruction set” and “text file” are employed interchangeably. Also, media files are considered to include, but not necessarily limited to, pictures, video, music or other types of audio or visual files. Each of the media files denotes a single content object.

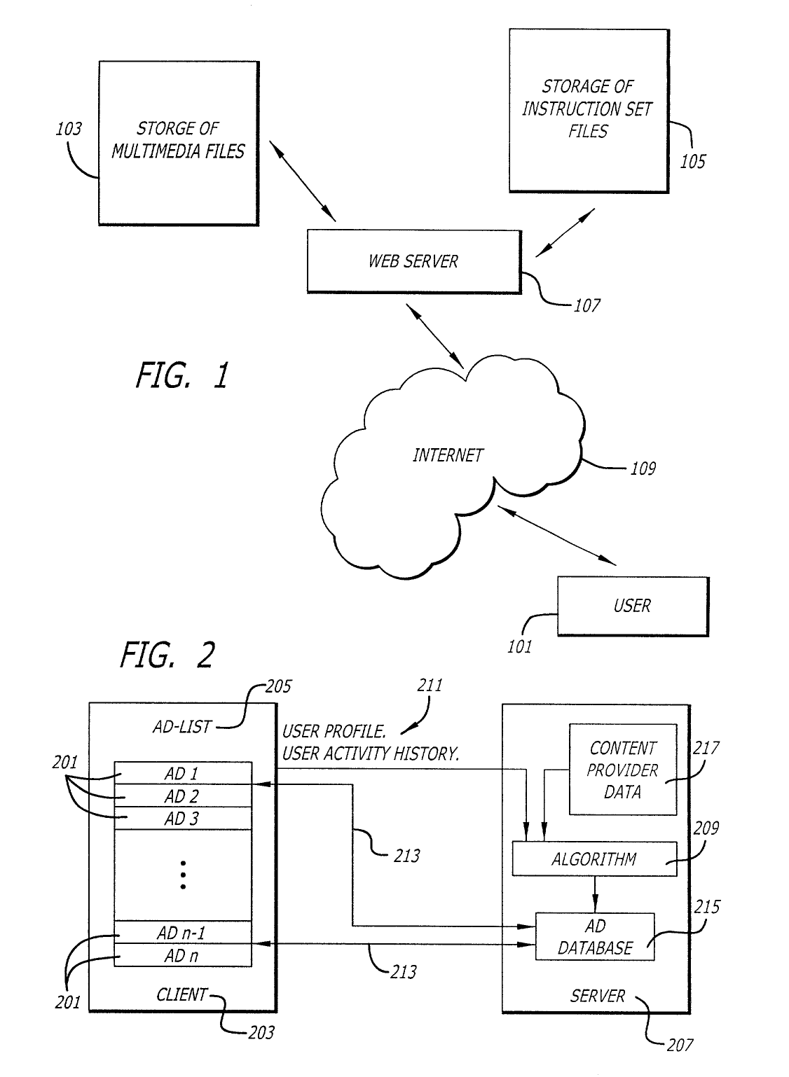

As illustrated in FIG. 1, a method exemplary of the present invention is employed in a system wherein users 101 on a client side access rich media files from a server 107 through an Internet connection 109 and play them back at the client side. The rich media files can be accessed from entertainment media file storage and advertisement media file storage. According to one such embodiment a user requests a show, comprising a series of entertainment and advertisement media files, from web server 107. The request also triggers delivery of an appropriate instruction set from storage 105 to user 101, to enable assembly and playback of the requested show.

The entertainment media files from storage 103 may be downloaded from a server 107 to a client at any time the client has available bandwidth. For example, a user 101 may decide to watch a movie and request that movie from the server 107. If the entertainment media files associated with that movie are not already resident at the client side, they are downloaded from the server 107 at that time. The media files from storage 103 are pre-cached on the client side, and thus are ready for playback.

In another example, a user may select one or more shows in advance. For example, shows may be selected one day even though there is no intent to view them until the next day. In this case, the entertainment media files associated with those shows are downloaded to the client and stored on the client's hard disk until such time as the user 101 requests playback.

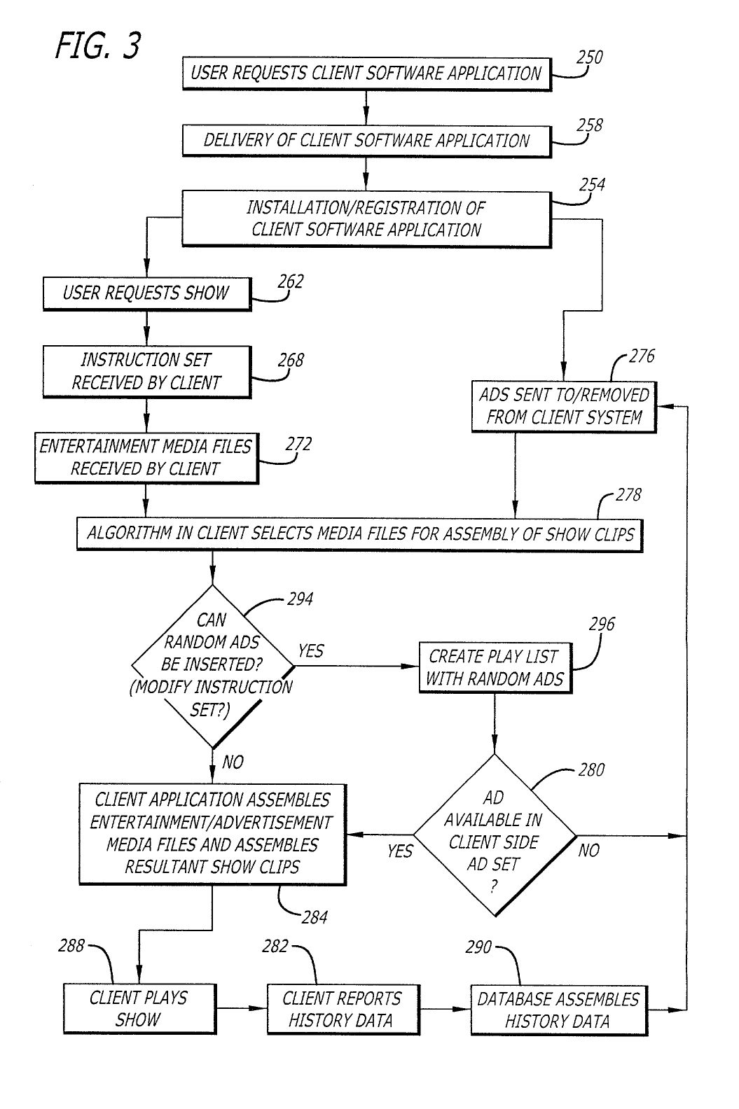

FIG. 2 illustrates the use of advertisement media files as a second component of a show. Advertisement media files 201 are generally resident on a user's client-side computer 203, although their existence is dynamic. That is, a user always possesses a set of advertisement files 205, and the server 207 is able to delete and add files from that set based on an algorithmic analysis 209 of user profile and activity history data 211. Activity history data 211 may include, but is not limited to, particular media files that a user has played, a length of time or percentage of completion during the play of a media file, and types and numbers of advertisement media files that have been seen by the user. The server 207 thus has control over the user's advertisement set, and maintains it using the user's idle bandwidth. While a user is connected to the Internet (see FIG. 1), regardless of his other activities on the Internet, if his client-side computer has idle bandwidth available, a system of an embodiment of the present invention may use the idle bandwidth to transfer, as shown by arrow 213, content from an advertisement file server 215 to the user's advertisement media file set 205.

The preferred content of a particular user's advertisement file set is determined by algorithms 209, which analyze user statistics and activity history data 211 in view of advertisement targeting data 217 provided by advertisement content providers. The user data 211 may be communicated to the server 207, for example, by a user identification (ID) provided by a user during interface with the server. The ID may then be matched with user-specific data that may, for example, reside in a database on the server 207. Other methods of communicating user data 211 to the server 207, such as the delivery to the server of a file stored and maintained at the client side, are possible. The data are then analyzed to determine specific content of a particular user's advertisement set. By this manipulation of user-specific advertisement media file sets, advertisement media files can be directly and specifically targeted to users.

In an exemplary embodiment of the invention and referring to the flow chart of FIG. 3, a user registers with a service (as depicted by block 250). Software is delivered for installation of a client-side application as illustrated by block 258. The software for the application is specifically designed for use in accordance with an embodiment of the invention, and supports user interaction between a client and a server (as depicted in FIGS. 1 and 2). Once the client-side application is installed 254, a user may begin requesting shows 262.

Show requests, indicated at block 262, can occur in one of at least two ways. First, a user can directly request a show, such as by browsing through a directory and selecting a show to request from the server. In a second method, a user can subscribe to a particular show, series of episodes, or genre of entertainment, for example. As episodes included in a subscription become available at the server-side, they are automatically delivered to the client using the client's idle bandwidth. In this manner, users can establish subscriptions for certain content or certain types of content and have that content automatically delivered at its earliest availability.

Once a user has established a subscription, the client application, on a scheduled interval, requests information from the server. Particularly, the client requests information related to its resident subscriptions. If a subscribed-to episode is available on the server, the server instructs the client application to order the show. Similar to the manner in which a user would directly order a show, then, the client application itself orders the show from the server. However, unlike direct ordering by a user, subscription ordering requires no user interaction beyond the initial user request for the subscription.

When a show is requested (block 262) from the server 207, an instruction set is delivered from the server to the client 203, as shown by block 268 in FIG. 3. The instruction set may be an HTML file or a text file that includes tags or other specific instructions to the client. The file is a listing of the order of the entertainment and advertisement media files that will make up the show that was requested by the user. It is created on the server side, in some instances at the time of the user's request, and may be specific to each user.

Upon a client's receipt of the instruction file, the client application begins utilizing the file and taking instructions from it. Accordingly, the various entertainment and advertisement media files are accessed from the client-side storage (blocks 272 and 276) and pre-cached. According to an embodiment of the invention, playback of a show comprising multiple clips begins only if either all of the clips' member media files are resident on the client side or if an algorithm at the client side or server side determines that subsequent media files will be downloaded from the server and resident at the client side prior to the time they are to begin playback. The algorithm thus enables playback to begin before all of the files are cached (block 278). That is, a movie may begin to play while media files that appear later in the movie are still being cached and assembled into clips.

Another feature of the invention provides for multiple initial media file belonging to more than one show to be pre-cached at the client side. This unique feature enables playback of any of the multiple shows to commence immediately upon user request. The remainder of the media files belonging to the show that does get played, then, will be downloaded and stored in cache during playback of that show.

After all of the necessary media files are resident at the client side (block 280), as described above, the client application assembles the entertainment and advertisement media files and begins playback of the various media files (and static images received by the client application) in the order specified by the instruction set, as depicted by blocks 284 and 288. Additional steps depicted in the flow chart of FIG. 3 are the reporting of history data 282, assembling of user history data 290 and the modifying of the instruction set 294 that results in creation of a play list 296; each of these steps is explained in greater detail elsewhere in this disclosure. As shown in FIG. 3, although the media files are never physically joined, the appearance to the user is that one single media file is being played as a continuous show clip.

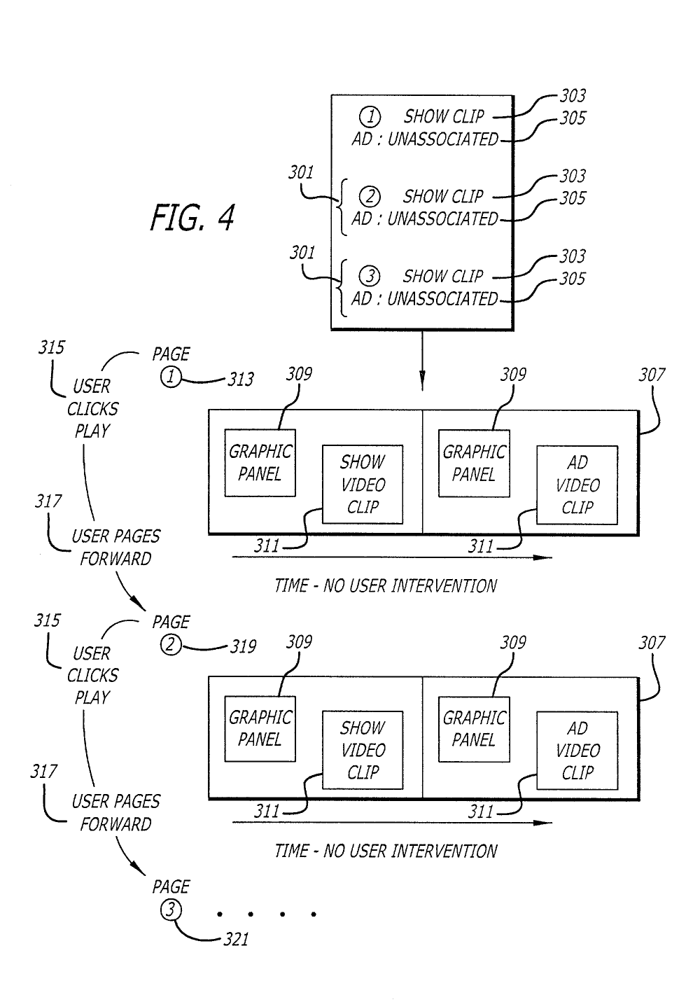

Thus, as shown in FIG. 4, an example of this invention involves show clips 301, each comprising an entertainment video media file 303 and an advertisement video media file 305. The playback of any show clip 301 occurs within an area on a computer screen denoted at “page” 307. Each page 307 comprises two sub-areas, namely, a graphic panel 309 that displays a static image and a clip panel 311 that displays a moving picture. In the example illustrated by FIG. 4, a user views a first page on his client-side computer screen and clicks a “play” button 313 displayed on the page. The assembled clip, comprising both the entertainment media files 303 and the advertisement media files 305, then plays within a page 307. While a fully assembled show clip preferably consists of separate media files such as an entertainment media file 303 and an advertisement media file 305, it proceeds through playback within the single page 307 to have the appearance of a single, continuous clip to the user. In other words, the user cannot discern the individuality of entertainment media files 303 and advertisement media files 305 because they are played seamlessly in series.

A multiplicity of pages 307 is referred to herein as a “magazine.” And within a magazine, a user can select different pages, such as by “paging forward” 317. Each page 307 plays a series of clips in clip panel 311 and displays associated static images in graphic panel 309.

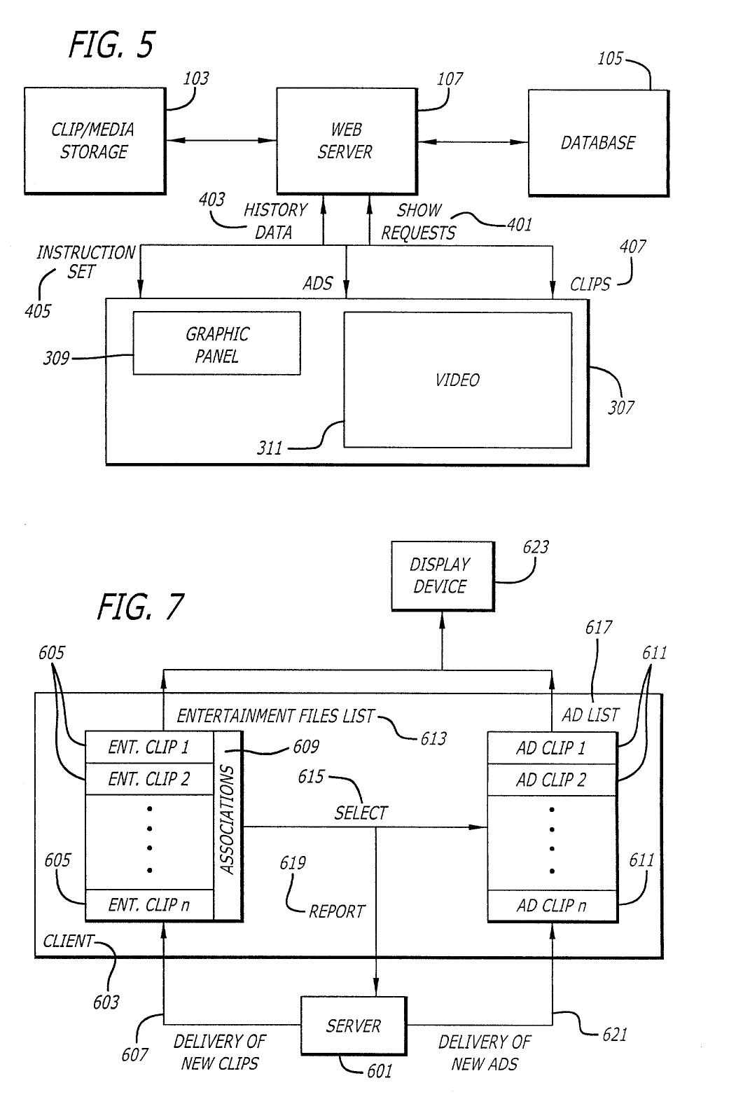

In an embodiment of the invention illustrated in FIG. 5, a user operates a client-side application, as described above, for example, that acts as an interface to the server side. The user requests shows 401 from web server 107. Also, user activity history data 403, indicative of user behavior patterns for example, is sent from the client to the server on scheduled intervals. The instruction set, or text file 405, that is sent from the server 107 is analyzed by the client-side application. The application then builds a show by performing the necessary steps as dictated by the instruction set. For example, it pulls media files 407 from storage as they are listed in instruction set 403. If advertisement media files listed in instruction set 405 are not already resident at the client side, then the appropriate advertisement media files 409 are retrieved from a server side advertisement file storage 105. As previously described, the application also plays the media files so that they have the appearance of a single, continuous clip. The sequence of multiple media files, including combinations of entertainment files and advertisement files, is retrieved from storage in response to a single request or action from the client side, whether the request is direct or derived from a user subscription.

In one embodiment, the media files play together sequentially, similar to a television show with commercials inserted at various points. The entertainment media files, which are preferably at least partially pre-cached at the client side, are blended with the advertisement media files, which are also preferably pre-cached at the client side. The entertainment media files include indications within the files, or possibly in an external file, pointing to where, if at all, the entertainment media files may have advertisement media files inserted therein. The entertainment media files also have indications indicating what type(s) of advertisement media files (both negative and positive associations) may be inserted. When a client-side user selects a particular entertainment file (e.g., a particular motion picture, music video or show), the server sends the entertainment file to the user, or the portion of the entertainment file that had not been previously pre-cached at the client side. The server also sends a text file containing a set of instructions indicating which advertisement media files from among the pre-cached advertisement media files to insert into the entertainment media file at run time, how many advertisement media files to insert, and where to insert them. The instruction file need not specify exactly which advertisement media files to insert; rather, the instruction file can allow the client application to make its own random or pseudo-random selection, subject to any positive and negative associations, for playing back with the entertainment media file. Whether the instruction set rigidly defines the advertisement media files to play, or whether it allows the client-side application some flexibility in choosing the advertisement media files to play, the client may report back to the server which advertisement media files were actually played and therefore presumably viewed. The server uses this information to update the advertisement play list and to charge advertisers based upon the number of advertisement media files played, how closely the user's demographic or activity profile matches the advertiser's ideal target audience, and other criteria.

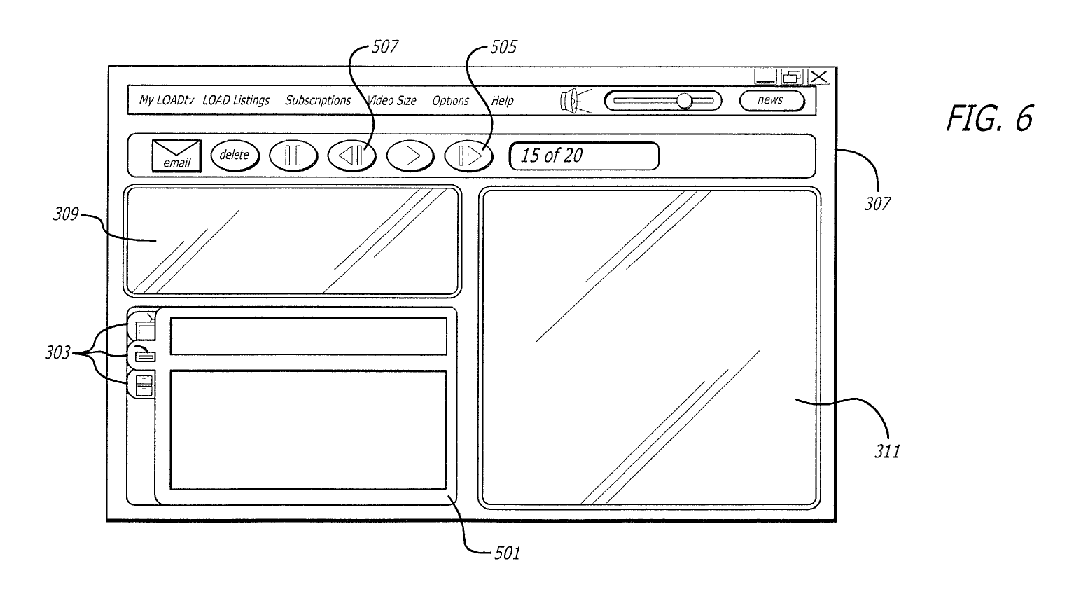

The application may have many different formats and appearances. The description will continue in an illustrative sense with the application having the appearance of a magazine as previously introduced and as shown, for example, in FIG. 6. A representation of a magazine 501 enables a user to select any page 307 within the magazine by selecting, such as with a mouse, a tab 503 associated with the page 311. A user may also move through different pages 311 within magazine 501 by using “forward” and “reverse” buttons 505, 507.

Different shows may be played on different pages within the magazine. A single segment of a show or the entire show plays on one page of the magazine. A page turn has the appearance of a visual transition between two different shows or, perhaps, two different segments within a show. Thus, a single page within a magazine provides an environment in which more than one media file can be played with the appearance of being one single show clip, i.e., a show or show segment comprising both entertainment and advertisement content. It is not discernable to the user that a show or show segment containing ads that plays in a single page of the application is actually a number of separate entertainment and advertisement media files.

According to this format of the client-side application, and as previously explained, a page 307 within a magazine comprises two sections. One section is a clip panel 311 in which entertainment and advertisement media files play sequentially as a single, continuous show clip, as described previously. A second section, called a graphic panel 309, displays static images, such as .jpg files or other artwork. For advertisement purposes and strategies, the artwork displayed in graphic panel 309 are preferably related to the media files that play within clip panel 311. One use of graphic panel 309 may be to drive traffic or build brand. Use of advertisement media files within a show in clip panel 311 occurs simultaneously with use of advertisement media files in graphic panel 309.

Similar to the ability of clip panel 311 to display various media files with the appearance of a single media file, graphic panel 309 contains links to various media files. From the single file displayed within graphic panel 309, the user is able to access a plurality of other media files. These files may include, for example, other pieces of art, a .pdf file, a Shockwave game, or audio files. Other types of files may be displayed in graphic panel 309 as well.

Returning to the panel which contains shows that are a series of video clips, the sequence of events relating to the arrangement of the various files prior to playback is particular and is dictated by the instruction set or text file. The text file lists the order of the show clips and contains the instruction sets surrounding each of the show clips. Upon request of a show or an episode by the user from the server, the text file arrives in the application first. The software organizes the list and begins calling out for the files that it needs to assemble each clip and, then, to assemble the clips to form an episode of a show. An example of an instruction that may appear in a text file is:

<ClipTag>
ShowID=1111,
PlayList=http://dl.sitename/folder1/folder2/clipname.zip,
Rating=rate,
Size=965,
</ClipTag>

This instruction to the client instructs the application to download the file “ClipName” and that it is a 965 KB file with a “rate” rating from show ID 1111. The client proceeds to download that media file from the server or locate it on the client's disk storage. According to an embodiment of the invention, the two <ClipTag> tags indicate the start and end of that page in the magazine. Page one, upon completion of the delivery of clipname.zip, is ready to be opened in the client-side application and play that video media file when the user so requests.

In an instance that involves use of the graphic panel, a piece of artwork would be downloaded separately from the video media file. The <ClipTag> section of the instruction set would thus include extra information to include directions for the download of the artwork. It may appear as follows:

<ClipTag>
PlayList=http://dl.sitename/folder1/folder2/clipname.zip,
Size=965,
Panel=http://dl.sitename/folder1/folder3/artname.jpg
Size=35,
Rating=rate,
</ClipTag>

In this case, when the client finishes downloading the PlayList entry (the video media file), it proceeds to download the artwork “artnamejpg.” According to a rule set of one embodiment of the invention, the client executes all instructions in the text file before any of the media files are played. Thus, any artwork specified by the text file to reside in the graphic panel is downloaded to the client before playback of any of the files begins. In this example, after the video media file and the artwork are downloaded and assembled into a show clip, the client application simultaneously plays the show clip in the first panel and displays the artwork in the graphic panel.

Following this model of downloading many media files and packaging them client side, many more tags may be included in the instruction set text files. The client treats any additional information that gets added to the ClipTag section as a part of a single clip. For example, other media files may be added for inclusion in the graphic panel with the following instruction set:

<ClipTag>
ShowID=1111,
PlayList=http://dl.sitename/folder1/folder2/clipname.zip,
Size=965,
Panel=http://dl.sitename/folder1/folder3/artname.jpg
Size=35,
Magazine=http://dl.sitename/folder1/folder4/adverclipname.pdf
Size=88,
Game=http://dl.sitename/folder1/folder5/game.wav
Size=533,
Music=http://dl.sitename/folder1/folder6/music.mp3
Size=320,
Rating=rate,
</ClipTag>

According to this instruction set, the client will download a video media file (clipname.zip), a piece of art (artname.jpg), a pdf file (adverclipname.pdf), a Shockwave game (game.wav), and a song (music.mp3). All of these files will be downloaded to the client before the client ever displays the resultant clip in the magazine. Collectively, all of the files occupy page one of the magazine.

A feature of an embodiment of the present invention is its use of advertisement media files. Advertisement files can be appended to a media file such that entertainment and advertisement files are played to appear as a single clip within one page of the magazine. Two new tags, not standard to HTML programming, have been developed as a feature of the invention (or as an independent invention) and are utilized to control the addition of advertisement files. Specifically, <ADInsert> and <ADOverlay> are two tags that are recognized by the client application as specific instructions regarding treatment of advertising media files. These two tags give the server complete control over the content and placement of the ads within a show, even though this is eventually carried out on the client side. Using these tags, the server can direct the client to place an ad before, during, or after a media file during playback of media files in the magazine page.

The <ADInsert> tag follows the same rules as the <ClipTag> tags. Therefore, the same set of examples previously described may be placed inside of <ADInsert> tags to define a single page within a magazine. Further, the client does not display any of the content until it is all downloaded.

An example of these tags working together within a single text file or instruction set is as follows:

<ClipTag>
<ADInsert>
PlayList=http://dl.sitename/folder1/folder2/adclip.zip,
Size=965,
Panel=http://dl.sitename/folder1/folder3/adart.jpg
Size=35,
Magazine=http://dl.sitename/folder1/folder4/adpage.pdf
Size=88,
Game=http://dl.sitename/folder1/folder5/adgame.wav
Size=533,
Music=http://dl.sitename/folder1/folder6/admusic.mp3
Size=320,
Rating=rate,
<ADInsert>
ShowID=1111,
PlayList=http://dl.sitename/folder1/folder2/clipname.zip,
Size=965,
Panel=http://dl.sitename/folder1/folder3/artname.jpg
Size=35,
Magazine=http://dl.sitename/folder1/folder4/adverclipname.pdf
Size=88,
Game=http://dl.sitename/folder1/folder5/game.wav
Size=533,
Music=http://dl.sitename/folder1/folder6/music.mp3
Size=320,
Rating=rate,
</ClipTag>

All of the information between the <ClipTag> tags defines a single page within a magazine. The information between <ADInsert> tags defines an advertisement. The placement of the <ADInsert> tags within the ClipTag section dictates the sequence of advertisement and entertainment media files. In this example, all of the content designated inside of the <ADInsert> tags is downloaded and then all of the content designated inside of the <ClipTag> tags is downloaded. After all of the content reaches the client system, the client begins to display the content in the application. The art (adart.jpg) and the advertisement media file (adclip.zip) are displayed by the client before the static image (artname.jpg) and the entertainment media file (clipname.zip) because of the placement of these files within the instruction set as defined above.

In the above example, the user experience is as follows. When the user directs the client application to begin playing the show, the advertisement (adclip.zip) begins playing in the first panel within the magazine. The graphic panel simultaneously displays the corresponding advertisement (adart.jpg). The graphic panel is also an interface to the other files listed in the <ADInsert> section of the instruction set. For instance, the user is able to activate defined areas of the graphic panel to initiate a game (ad.wave), a pdf file (ad.pdf), or music (ad.mp3). These files are initiated by being accessed and launched from the client's hard drive.

When the advertisement (adclip.zip) is finished playing in the first panel, the entertainment media file (clipname.zip) begins to play in the same panel. This transition occurs without the appearance of a page turn within the magazine. In other words, the user is unable to discern that the advertisement media file and the entertainment media file contained in the show clip are actually separate files. The files are organized and arranged at client side to play sequentially with the appearance of a single, continuous clip. When the entertainment media file begins playing, the graphic panel simultaneously begins to display the associated artwork (artname.jpg). Linked behind this artwork will be the corresponding Shockwave, pdf, and mp3 files.

To demonstrate the function of content placement inside of the <ClipTag> section, the above example is repeated with re-arranged content:

<ClipTag>
ShowID=1111,
PlayList=http://dl.sitename/folder1/folder2/clipname.zip,
Size=965,
Panel=http://dl.sitename/folder1/folder3/artname.jpg
Size=35,
Magazine=http://dl.sitename/folder1/folder4/adverclipname.pdf
Size=88,
Game=http://dl.sitename/folder1/folder5/game.wav
Size=533,
Music=http://dl.sitename/folder1/folder6/music.mp3
Size=320,
Rating=rate,
<ADInsert>
PlayList=http://dl.sitename/folder1/folder2/adclip.zip,
Size=965,
Panel=http://dl.sitename/folder1/folder3/adart.jpg
Size=35,
Magazine=http://dl.sitename/folder1/folder4/adpage.pdf
Size=88,
Game=http://dl.sitename/folder1/folder5/adgame.wav
Size=533,
Music=http://dl.sitename/folder1/folder6/admusic.mp3
Size=320,
Rating=rate,
<ADInsert>
<ClipTag>

In this example, the client displays the entertainment media file and associated graphic panel content before it plays the advertisement media file with its associated graphic panel content. According to this instruction set, once the user directs the client application to begin playing the show, the client begins to play the entertainment media files in the first panel within the magazine. The associated files are displayed in the graphic panel on the same page of the magazine. When the entertainment media file is finished playing, the advertisement media file immediately proceeds, without the appearance of a page turn. Again, the user perceives a single, continuous show clip without being able to discern that the client has actually played two separate media files.

The use of the <ClipTag> and <ADInsert> tags alone do not allow for complete control over the content of a show once delivered to the client. To maintain this control, a second new tag is used. According to an embodiment of the invention, this tag is called <ADOverlay>, and is used to allow for the client to actually replace media in contrast to the previously-described apparent joining of media. By using this tag, the client can actually alter the content of media files that were previously delivered by the server. Therefore, real-time management of media content is possible on the client-side.

FIG. 7 illustrates this real-time management feature of the invention. A show, comprising a plurality of clips, has its associated instruction set stored on server 601. The instruction set is delivered from server 601 to client 603, and the client follows the instructions therein for retrieving and organizing clips to assemble and playback as a show. According to the instructions, entertainment media files 605 are delivered as shown by arrow 607 from server 601 to client 603. Each entertainment file 605 has an association 609, which indicates a type of advertisement media file 611 that may be appropriate or inappropriate to be coupled with the entertainment media files within a show clip. For example, a children's show may not be compatible with cigarette or alcohol advertisement media files. Also, once an advertisement media file 611 featuring a particular brand has been selected for inclusion in a show, an advertisement media file with a competing or conflicting brand may be prohibited from inclusion in the remainder of the show. All of this information is detailed in associations 609, and will be explained more fully later.

As the entertainment media files 605 are assembled in playback list 613, advertisement media files 611 are selected as shown by arrow 615, according to associations 609. Should a desired advertisement media file 611 not already be present in advertisement list 617 on client 603, a report 619 is sent to client 601, triggering real-time delivery of new advertisement media files 621. Once sufficient entertainment media files 605 and advertisement media files 611 are selected and assembled, playback of the assembled show begins on a display device 623, such as a computer monitor.

To control advertising content for particular users, such as to optimize targeting of specific advertisement media files to specific users, an instruction set can include calls to particular advertisement media files known to be directed to particular demographic groups. Based on each user's personal data, then, an instruction set can be delivered to a user as a newly-refined text file with an inserted <ADOverlay> section containing an advertisement directed for a different demographic that more closely matches that of the user making the request. Thus, the normal content of a show as stored on a server may be altered by the client if the client receives a text file that instructs it to overlay different media files within that show's clips. This is done real-time in the sense that the overlaid sections are determined at the time of the user request based on that user's demographic and activity history data, and that the overlaid sections are not inserted by the client until a request to play the media has been made by the user.

An example of an instruction set allowing client-side overlay of media content is as follows:

<ClipTag>
<ADOverlay>
PlayList=http://dl.sitename/folder1/folder2/adclip.zip,
Size=965,
Panel=http://dl.sitename/folder1/folder3/adart.jpg
Size=35,
</ADOverlay>
ShowID=1111,
PlayList=http://dl.sitename/folder1/folder2/clipname.zip,
Size=965,
Panel=http://dl.sitename/folder1/folder3/artname.jpg
Size=35,
Magazine=http://dl.sitename/folder1/folder4/adverclipname.pdf
Size=88,
Game=http://dl.sitename/folder1/folder5/game.wav
Size=533,
Music=http://dl.sitename/folder1/folder6/music.mp3
Size=320,
Rating=rate,
</ClipTag>

In this example, the <ADOverlay> tags immediately precede the advertising entry that the overlay content will replace. Once all of the files listed in the instruction set are downloaded, the client begins to display the content. In this example, when the user requests the client application to begin playing the show, the advertisement (adclip.zip) begins playing while the associated artwork (adart.jpg) is displayed in the graphic panel. Because these files are contained in the <ADOverlay> section immediately preceding the show entertainment media file (clipname.zip), the advertisement replaces the entertainment media file, and the entertainment media file is not seen by the user. By this method, overlay of play list content is conducted client side and the user is not inconvenienced by standard waiting times involved with such content management being performed on the server side. The content management is effectively transferred to the client side, while maintaining content control on the server side.

The description now turns to the specifics of the advertisement files within a show. The invention may utilize two advertising models, termed Associated Advertising Model (AAM) and Unassociated Advertising Model (UAM).

In the AAM, a show and its corresponding advertisement media files must be associated with one another. While they exist as separate files in accordance with the rules of one embodiment of the invention, in that embodiment they must be played together by the client-side application. Effectively then, every time an AAM show is played it will have the same advertisement(s) within it for that particular association. The AAM allows for changes in associations to be made. An association change, therefore, would result in a modification to the list of associated advertisement media files. Association changes in the AAM occur on the server side.

In the UAM, a content provider may allow for an entire range of advertisement media files to be displayed in correspondence with the show. In this case, each time a UAM show is played, it may have different advertisement media files within it.

The AAM has a specific construction and design. A show is defined by an instruction set, e.g., an HTML file, that is stored on a web-based server. That instruction set will contain specific commands for a particular advertisement. An example of an instruction set according to the AAM is as follows:

<ClipTag>
<ADInsert>
PlayList=http://dl.sitename/folder1/folder2/adclip1.zip,
Panel=http://dl.sitename/folder1/folder3/adart1.jpg
ClipID=10011,
Rating=rate,
Size=655,
</ADInsert>
<ADOverlay>
Panel=http://dl.sitename/folder1/folder3/overlayart.jpg,
</Overlay>
ShowID=1111,
PlayList=http://dl.sitename/folder1/folder2/clipname.zip,
Panel=http://dl.sitename/folder1/folder3/artname.jpg
ClipID=11534,
Rating=rate,
Size=350,
<ADInsert>
PlayList=http://dl.sitename/folder1/folder2/adclip2.zip,
Panel=http://dl.sitename/folder1/folder3/adart2.jpg
ClipID=184673,
Rating=P,
Size=5346,
</ADInsert>
</ClipTag>

According to this instruction set, all of the listed files will be downloaded to the client before any of the files may begin to play. Once the files have all been downloaded, the play will execute as follows. An advertisement (adclip1.zip) will play in the first panel of the magazine. Simultaneously a piece of art (adart1.jpg) will be displayed in the graphic panel on the same page within the magazine. The advertisement is hard-coded in the instruction set as it is stored on the server, and is thus considered an associated advertisement. This classifies the show as being one that falls under the AAM. Once the advertisement has finished playing, and without execution of a page turn, the entertainment media file (clipname.zip) will begin to play in the first panel. Instead of its associated artwork (artname.jpg) however, the graphic panel will display the art listed in the preceding <ADOverlay> section (overlayart.jpg). After the entertainment media file has finished playing, and still without a page turn, a second ad (adclip2.zip) will play in the first panel, while its corresponding art (adart2.jpg) will be displayed in the graphic panel. This sequence will all occur on one page inside of the magazine.

The UAM is more complex. In this model, the server will deliver, based on profile and aggregate statistical data processed through an algorithm, a list of ads to the user. In periods of latent bandwidth, the client will download the ads designated by that list, one at a time. These ads will be kept in a folder on the user's computer. One possible example of such a list is:

<Advertisement>ID=23040>,PlayList=http://dl.sitename.com/rootfolder/Folder1/Advertisement/
ad02.zip ,Rating=rate,</Advertisement>
<Advertisement>ID=23041>,PlayList=http://dl.sitename.com/rootfolder/Folder1/Advertisement/
ad03.zip,Rating=rate,</Advertisement>
<Advertisement>ID=23042>,PlayList=http://dl.sitename.com/rootfolder/Folder1/Advertisement/
ad04.zip,Rating=rate,</Advertisement>
<Advertisement>ID=23043>,PlayList=http://dl.sitename.com/rootfolder/Folder1/Advertisement/
ad05.zip,Rating=rate,</Advertisement>
<Advertisement>ID=23044>,PlayList=http://dl.sitename.com/rootfolder/Folder1/Advertisement/
ad06.zip,Rating=rate,</Advertisement>
<Advertisement>ID=23045>,PlayList=http://dl.sitename.com/rootfolder/Folder1/Advertisement/
ad07.zip,Rating=rate,</Advertisement>
<Advertisement>ID=23046>,PlayList=http://dl.sitename.com/rootfolder/Folder1/Advertisement/
ad08.zip,Rating=rate,</Advertisement>
<Advertisement>ID=23047>,PlayList=http://dl.sitename.com/rootfolder/Folder1/Advertisement/
ad09.zip,Rating=rate,</Advertisement>
<Advertisement>ID=23048=,PlayList=http://dl.sitename.com/rootfolder/Folder1/Advertisement/
ad10.zip,Rating=rate,</Advertisement>

The client, during times of available bandwidth, would download content to this list of ads on the user's computer. Each of these ads would carry with it a text file of its own, containing a rule set for the ad. These rules could include (but would not necessarily be limited to):

1) times the ad is to be played

2) brand exclusivity values

3) category exclusivity values

4) rating

Thus, resident on the client's system is a list of “targeted” advertisement media files geared to that particular user. The advertisement list would be dynamic, in that it would always be accessible by the server, and its content always subject to modification. Upon access of the list by the client, for example when the client-side application takes an ad from the list to play within a show, data may be sent to the server reporting the activity of that advertisement. These data may be used in the future for selection of advertisement media files to include with a show.

The client will be directed to access advertisement media files from a user's advertisement list by the instructions it receives in the instruction set, or HTML file, associated with a user-requested show. An example of such a text file is as follows:

<HTML>
<Show>
Name=Show Name,
SSub=1,
SID=48100,
SCat=,
SCat=0,
</Show>
<Episode>
ETitle=Episode Name,
IDNumber=48100_1_7,
EOv1ID=0,
NumVids=4,
ERaP=Rate,
ECDArt=CDart.jpg,
EMaxAds=0,
Size=8484,
</Episode>
<ClipTag>
<LOADIns>
</LOADIns>
ClipID=41382,
PlayList=http://dl.sitename.com/folder1/folder2/clip01.zip,
Rating=P,
Size=2140,
Panel=episodeart.jpg,
<LOADIns>
</LOADIns>
</ClipTag>
<ClipTag>
<LOADIns>
</LOADIns>
ClipID=41383,
PlayList=http://dl.sitename.com/folder1/folder2/clip02.zip,
Rating=P,
Size=2155,
Panel=episodeart.jpg,
<LOADIns>
</LOADIns>
</ClipTag>
<ClipTag>
<LOADIns>
</LOADIns>
ClipID=41384,
PlayList=http://dl.sitename.com/folder1/folder2/clip03.zip,
Rating=P,
Size=2231,
Panel=episodeart.jpg,
<LOADIns>
</LOADIns>
</ClipTag>
<ClipTag>
<LOADIns>
</LOADIns>
ClipID=41385,
PlayList=http://dl.sitename.com/folder1/folder2/clip04.zip,
Rating=P,
Size=4958,
Panel=episodeart.jpg,
<LOADIns>
</LOADIns>
<ClipTag>
</HTML>

The instruction set in this example directs to pull advertisement files from its local cache to be played in the show. The text occurring after <HTML> and before the first <ClipTag> entry is the show section. If the show is marked as one which will accept advertisement media files, a meta tag will be added in the show section. It might look like this:

<Episode>
Size=11502,
EID=323200_1_15,
EAdok=,
EMaxads=1,
EVids=1,
CPCLSI=,
CPCLSE=,

Where the meta tag EADOK is marked true (1), the show is allowed to accept advertisement media files. Placement of advertisement media files within the show can be indicated in one of two ways. A content provider, who provides the server with media content, can specify which clips may be preceded or followed by ads. The other way is that it may be allowable for ads to be placed randomly within a show. In either case, the construction of a show and arrangement of the media files to create a show that has a particular order is done on the client side.

A variety of other tags may be used to control advertisement media files that are allowed a certain degree of randomness in their placement within a show. For example, an EMAXAD tag can be used to define the maximum number of ads that may be allowed to appear within a show. A CPI tag may be used to indicate specific advertisement media files that a content provider will allow in a show, or specific brands that are allowed to be associated with a show. A CPCLSI tag (a positive association tag) would indicate any category of content that the content provider would allow or requires to be associated with the show. For example, a content provider that is related to a soft drink maker might require that an advertisement for one of the maker's soft drinks always be included with a particular show. In contrast, a CPCLSE tag (a negative association tag) would indicate any category of content that a content provider would indicate as unacceptable for advertisement with a show. For example, a content provider might require that no alcoholic beverage advertisement media files be inserted into its shows, or no advertisement media files from a rival content provider. Another possibility is for advertisement to be determined based upon brand. These examples constitute only a few of a variety of meta tags that may be created and utilized to define a rule set used for the control of advertising content within a show.

This type of rule set allows for calculations to determine which advertisement media files already cached onto the user's hard drive can be inserted into a show. In other words, the tags allow for real time determination of advertisement content within a show on the client side. Further, the advertisement media files may be classified as associated or unassociated, may be inserted or overlaid, and are accordingly handled real-time by the client. Again, associations may be positive associations or negative associations.

In an embodiment of the invention, the instruction set used by the client to insert media files may be modified by the client at playback. The modifications may be based on randomly-inserted advertisement media files that have already been inserted in a show. For example, a first unassociated advertisement may be designated as the only advertisement allowed from a certain brand or category. The client would thus modify the instruction set as it relates to future advertisement media files within the same show. That is, according to the association of that first advertisement, a second advertisement as deemed allowable by the instruction set prior to inclusion of the first advertisement, may no longer be allowable. This may be driven, for example, by conflicting brands between the two advertisement media files. In such an instance, the client will make a real-time amendment to the instruction set, altering the requirements for permissible advertisement media files within the remainder of that show. This may be accomplished, for example, by replacing tags within the instruction set.

Also, a show may contain a combination of associated advertisement media files and unassociated advertisement media files. For example, a show may have a certain advertisement that is always associated with it, and the same show may also accept a number of unassociated advertisement media files. Another possibility is that a show may have a certain number of entertainment media files marked to accept unassociated advertisement media files, and only a portion of those entertainment media files may actually be played with advertisement media files. Further, during various playbacks of such a show, advertisement media files may be played with different entertainment media files. That is, the location of advertisement media files within a show may be determined by various criteria at the time of playback. These criteria may include, but would not be limited to, randomness such that a user would not experience identical advertisement placement during repeated viewing of a single show, or incentive systems whereby, for example, the number of advertisement media files may be determined by the occurrence or level of a fee paid by the user. In any case, while each show appears to the user as a single, continuous show, it is in reality a series of separate clips, comprising individual media files selected, organized and played sequentially on the client-side.

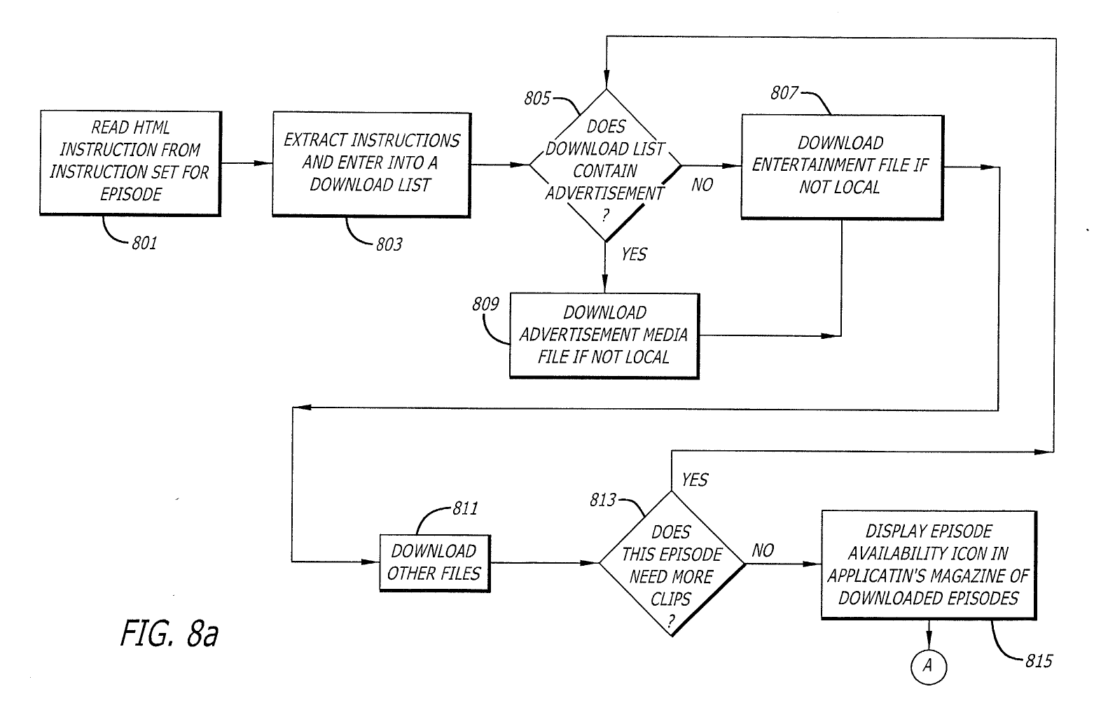

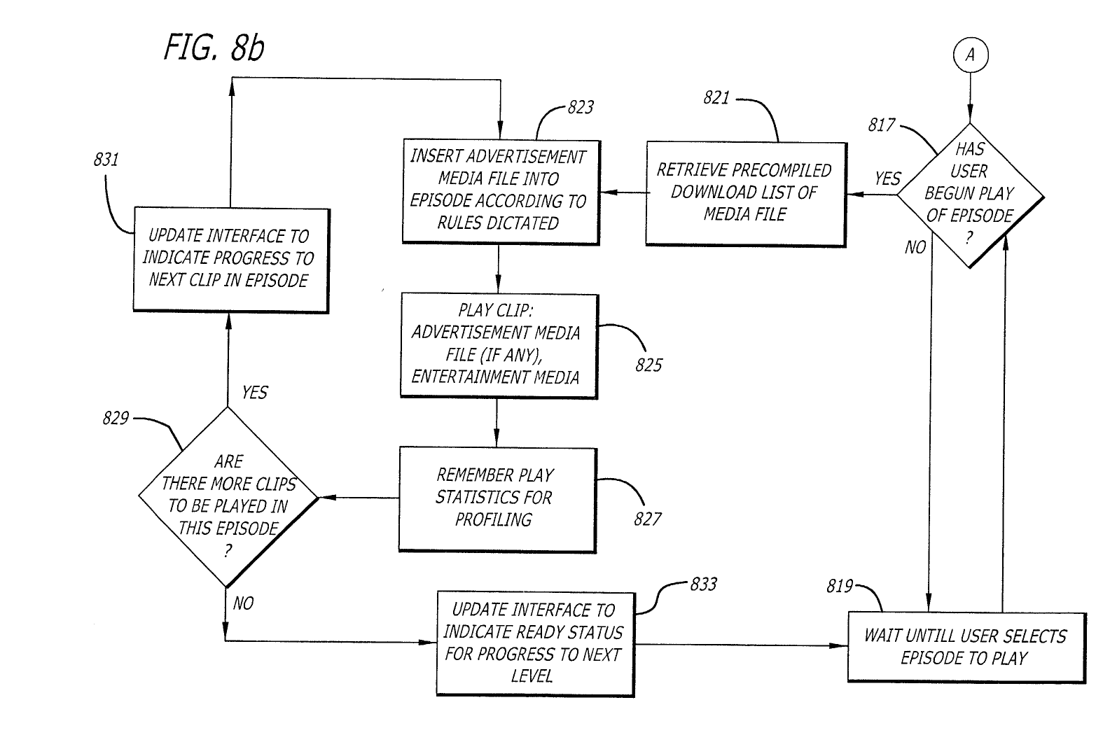

FIG. 8 is a flowchart illustrating an exemplary scenario encountered by a user of the present invention, according to the details herein. Upon requesting an episode, either through a user's direct request or through the subscription mechanism, an instruction set for the episode is delivered to the client. The client application reads the HTML instruction set for the episode, as indicated at 801. At 803, instructions relative to files that belong to the episode and that need to be downloaded, are entered and compiled into a download list. The download list, then, is a set of instructions used by the client application to retrieve the files, whether entertainment, advertisement, video, image, etc., necessary for compilation of the episode.

At block 805, it is determined whether the download list contains instructions for including an advertisement in a clip of the episode. If not, the client application proceeds to download the first non-advertisement media file for the episode at 807. If an advertisement media file instruction is present in the download list, however, the client first downloads the advertisement from the server at 809, if the advertisement file is not already stored locally in the client's advertisement set, and then proceeds to download the non-advertisement media file for the episode at 807. Remaining media files, such as panel images or other media for presentation within a magazine page, are then downloaded at 811. At 813, it is determined whether more clips must be assembled for the episode. If so, the client application returns to 805, where it begins processing instructions from the download list for the next clip in the episode. Once all of the clips have had their components downloaded, the client system proceeds forward from 813.

When an entire episode has been downloaded, after the final pass through block 813, an indicator is placed in the client application's magazine at 815. This indicator may be an availability icon or other indicia. The availability icon indicates, to a user of the client application, that the episode is fully downloaded at the client-side and is available for playback by the user.

At block 817, a user begins play of the episode. This step occurs at the user's discretion, and the client application waits for the user's request, as indicated at 819. Once play begins, the precompiled download list (created at 803) is retrieved at 821. The client application follows the instructions contained in the download list to insert advertisement media files into the episode at 823. Typically, a single clip would have an advertisement at its beginning, at its end, both, or not at all. The clip's entertainment media files and its requisite advertisement media files are assembled by the client application at 823 according to the download list. The clip, once assembled, is sent to a media player contained within the client application, at 825. The media player can be a custom software application, or can be a standard media player. In the case of a standard media player, the client application is “wrapped around” the media player, as is commonly practiced in the art.

As a clip is played within the client application/media player, user statistics are generated and stored by the client application at 827. These statistics can include, but are not limited to, length of play, number of times played, or percent completed. The statistics characterize the user's behavior patterns, and are eventually sent to the server, at regularly scheduled intervals, by the client application.

After a clip has been delivered to the media player, the client application determines whether there are more clips in the episode at 829. If so, the client application display, or interface, is updated to indicate progress to the next segment of the episode at 831. The indication may be a counter located on the interface, a slide bar, or some other form of indication. The client application then proceeds to compile the next clip at 823, as previously described. This process is repeated until all of the episode's clips have been assembled and delivered to the media player.

When all clips of the episode have been assembled and delivered to the media player, the interface is updated to indicate progress to the next episode at 833. The indication may be a statement reading “Ready to Play” or some other form of indication. The client application then waits for the user to select another episode at 819.

The foregoing description of the preferred embodiments of the invention has been presented for the purposes of illustration and description. It is not intended to be exhaustive or to limit the invention to the precise form disclosed. Many modifications and variations are possible in light of the above teaching. For example, the term “entertainment” file is intended to encompass any file that a viewer desires to see, including news, documentaries, and other informational files. The invention is also not limited to being used for entertainment and advertisement media files across the Internet. Rather, the invention may be used for different types of files across a wide variety of computer and communications networks.

It will be appreciated that the term “present invention” as used herein should not be construed to mean that only a single invention having a single essential element or group of elements is presented. Rather, each novel and nonobvious element constitutes a separate invention. Further, each novel and nonobvious combination of elements enabled by the present disclosure, whether the individual elements therein are old elements, new elements, or any combination thereof, further constitutes an additional separate invention. It is intended that the scope of the invention be limited not by this detailed description.

What is claimed is:

1. A method of displaying media files, comprising:
delivering to a client a set of first media files from a server;
delivering to the client from a server a set of second media files;
pursuant to an instruction set received from a server, assembling at the client the first media files and at least one of the second media files to form a continuous show; and
playing the show as a single continuous play.

2. The method of claim 1 wherein the continuous show is displayed on a display screen.

3. The method of claim 2 wherein the display screen comprises a first display area for displaying the continuous show and a second display area for displaying at least one static image delivered to the client from the server.

4. The method of claim 1 wherein the set of second media files are advertisement media files.

5. The method of claim 4 wherein the advertisement media files are static image media files.

6. The method of claim 4 wherein the advertisement media files are video media files.

7. The method of claim 4 wherein the advertisement media files are audio media files.

8. The method of claim 1 wherein the delivering to a client a set of first media files is in response to a user request.

9. The method of claim 8 wherein the user request is a direct request to the server.

10. The method of claim 8 wherein the user request is derived from a user subscription.

11. The method of claim 1 wherein the delivering to a client a set of second media files is periodical and is in accordance with user behavior statistics.

12. The method of claim 11 wherein the user behavior statistics are collected, stored, and delivered to the server by the client.

13. The method of claim 12 wherein the user behavior statistics include types of media files a user has requested and identification of advertisement media files that have been selected and played at the client.

14. The method of claim 1 wherein the server having a set of first media files delivered therefrom, the server having a set of second media files delivered therefrom, and the server having an instruction set received therefrom comprise the same single server.

15. The method of claim 1 wherein the server having a set of first media files delivered therefrom, the server having a set of second media files delivered therefrom, and the server having an instruction set received therefrom comprise multiple servers.

16. A method of providing media with advertising to a client, comprising:
pre-caching a plurality of entertainment media files at a client side;
pre-caching a plurality of advertising media files at the client side;
providing insertion indications indicating where the entertainment media files may have advertisement media files inserted therein;
providing association indications regarding what types of advertisement media files may be inserted in the entertainment media files;
receiving from the client a command to play one or more of the pre-cached entertainment media files; and
sending to the client a text file, the text file including instructions embedded therein, the instructions directing the client regarding the entertainment media files and the advertising media files to be assembled together, and in what order, for playback with the appearance of a single media file.

17. The method of claim 16 wherein the playback is displayed on a display screen and the advertising media files comprise static images.

18. The method of claim 17 wherein the display screen includes a first display area for displaying the playback, and a second display area adjacent to the first display area, the second display area displaying the static images concurrent with the playback.

19. The method of claim 16 wherein the insertion indications are contained within the entertainment media files.

20. The method of claim 16 wherein the association indications are contained within the entertainment media files.

21. The method of claim 16 wherein the sending a text file is in response to the command to play accepted from the client.

22. The method of claim 16 wherein the insertion indicators are included within the text file.

23. The method of claim 16 wherein the association indicators are included within the text file.

24. The method of claim 16 wherein the pre-caching a plurality of media files at the client side is in response to a user request.

25. The method of claim 24 wherein the user request is a direct request from a user.

26. The method of claim 24 wherein the user request is derived from a user subscription.

27. The method of claim 16 wherein the advertising media files are static image media files.

28. The method of claim 16 wherein the advertising media files are video media files.

29. The method of claim 16 wherein the advertising media files are audio media files.

30. The method of claim 16 wherein the sending a text file is concurrent with the pre-caching a plurality of entertainment media files.

31. The method of claim 16 wherein the association indications indicate types of advertisement media files which cannot be inserted into an entertainment media file.

32. A method of providing entertainment combined with advertising, comprising:
delivering a plurality of advertisement media files from a server to a client across a computer network for caching at the client, the cached advertisement media files defining a menu of cached advertisement media files; and
delivering both an entertainment file and an advertising designation to the client, the entertainment file and the advertising designation being associated together such that the client will combine both the entertainment file and selected advertisement media files from the menu of cached advertisement media files, for playback together.

33. The method of claim 32 wherein the playback is within a first panel of a display screen having at least the first panel and a second panel.

34. The method of claim 33 wherein the second panel displays static images delivered to the client from the server, the static images being related to the playback with respect to content.

35. The method of claim 32 wherein the selected advertisement media files are fewer than all of the cached advertisement media files.

36. The method of claim 32 wherein the delivering both an entertainment file and an advertising designation to the client is in response to a request from a user.

37. The method of claim 36 wherein the request from a user is a direct user request.

38. The method of claim 36 wherein the request from a user is derived from a user subscription.

39. The method of claim 32 further comprising modifying the advertising designation during playback of the files.

40. The method of claim 39 wherein the modifying is by the client.

41. The method of claim 32 further comprising modifying the advertising designation immediately prior to playback of the files.

42. The method of claim 41 wherein the modifying is by the client.

43. The method of claim 41 wherein the modifying is based upon a category of an advertisement file that has already been played back.

44. The method of claim 32 wherein the selected advertisement media files are selected by the server.

45. The method of claim 32 wherein the selected advertisement media files are selected by the client in response to criteria regarding the user and criteria contained within the advertising designation.

46. The method of claim 32 wherein the selected advertisement media files are selected by the client from the menu in response to the advertising designation, the advertising designation requiring that a pre-defined category of advertisement media files be included for playback with the entertainment file.

47. The method of claim 32 wherein the selected advertisement media files are selected at least in part by the server, and at least in part by the client.

48. The method of claim 32 wherein the advertising media files are static image media files.

49. The method of claim 32 wherein the advertising media files are video media files.

50. The method of claim 32 wherein the advertising media files are audio media files.

51. A method of providing entertainment and advertising, comprising:
delivering a plurality of advertisement media files to a client across a communications network for storage at the client, the advertisement media files defining a client library;
receiving a request from a user at the client to deliver a media object to the client;
modifying the client library; and
in response to the request, delivering the media object to the client for playback together with at least some of the advertisement media files from the client library.

52. The method of claim 51 wherein the modifying is based upon criteria that are provided by a supplier of the media object and are associated with the media object.

53. The method of claim 51 wherein the advertising media files are static image media files.

54. The method of claim 51 wherein the advertising media files are audio media files.

55. The method of claim 51 wherein the advertising media files are video media files.

56. The method of claim 51 wherein the request from a user is a direct user request.

57. The method of claim 51 wherein the request from a user is derived from a user subscription.

58. The method of claim 51 wherein the modifying is based upon user behavior statistics.

59. The method of claim 58 wherein the user behavior statistics are collected, stored, and delivered to a server by the client.

60. A method of advertising, comprising:
delivering across a computer network a content object, the object having a plurality of predefined advertisement media file insertion slots; and
selecting only some of the slots for insertion of advertisement media files thereat at the client side.

61. The method of claim 60 wherein the selecting of only some of the slots is on a pseudo-random basis.

62. The method of claim 60 wherein the content object includes a tag which defines a maximum number of advertisement media files allowed to be inserted within the content object.

63. The method of claim 60 wherein the content object includes a tag which designates a pre-defined category of advertisement media files to be inserted within the content object.

64. The method of claim 60 wherein the content object includes a tag which designates a pre-defined category of advertisement media files to be excluded from insertion within the content object.

65. The method of claim 60 wherein the advertising media files are static image media files.

66. The method of claim 60 wherein the advertising media files are audio media files.

67. The method of claim 60 wherein the advertising media files are video media files.

68. The method of claim 60 wherein the selecting is in accordance with user behavior statistics.

69. The method of claim 68 wherein the user behavior statistics are collected, stored and delivered to the server by the client.

70. A method of displaying multiples files at a client side, comprising:
delivering multiple media files to a client side from a server;
pursuant to an instruction set, selecting on the client side more than one of the media files;
pursuant to the instruction set, arranging on the client side the selected media files; and
playing the arranged media files as a continuous show.

71. The method of claim 70 wherein the instruction set is delivered from the client side to the server side.

72. The method of claim 70 wherein the multiple media files comprise entertainment media files.

73. The method of claim 72 wherein the multiple media files further comprise an advertisement media file.

74. The method of claim 73 wherein the advertisement media file is a static image media file.

75. The method of claim 73 wherein the advertisement media file is a video media file.

76. The method of claim 73 wherein the advertisement media file is an audio media file.

77. The method of claim 70 wherein the delivering multiple media files is in response to a user request.

78. The method of claim 77 wherein the user request is a direct request by the user to the server.

79. The method of claim 77 wherein the user request is derived from a user subscription.

80. A client system, comprising:
a client computer programmed (a) to receive from a server entertainment media files and at least one advertisement media file, (b) to assemble pursuant to an instruction set received from a server the media files and the at least one advertisement media file as a continuous show and (c) to play the show as a single continuous file.

81. The system of claim 80 wherein the show includes the at least one advertisement media file being positioned between entertainment media files.

82. A web server system, comprising:
a server programmed to deliver to a client (a) at least one advertisement media file, (b) at least one entertainment media file, and (c) an instruction set which instructs the client how to assemble the at least one advertisement media file and the at least one entertainment media file as a continuous show.

83. The system of claim 82 wherein the continuous show includes the at least one advertisement media file being inserted between the clips.

84. The system of claim 82 wherein the at least one advertisement media file includes a plurality of advertisement media files, the server is programmed to deliver the plurality of advertisement media files to the client for pre-caching before the clips are delivered, and the instruction set instructs the client how to assemble more than one of the advertisement media files with the clips to form the continuous show.

85. The system of claim 82 wherein the server is programmed to deliver the entertainment media files and the instruction set when a user selects the continuous show.

86. The system of claim 85 wherein the user selects the continuous show directly from the server.

87. The system of claim 85 wherein the user selects the continuous show by establishing a subscription with the server.

88. The system of claim 85 wherein the server is programmed to deliver the at least one advertisement media file to the server for pre-caching before the entertainment media files are delivered to the client.

89. The system of claim 82 wherein the at least one advertisement media file includes a plurality of advertisement media files.

90. The system of claim 89 wherein the continuous show includes all of the advertisement media files.

91. The system of claim 89 wherein the continuous show includes fewer than all of the advertisement media files.

92. The system of claim 89 wherein the plurality of advertisement media files comprises at least one static image media file.

93. The system of claim 89 wherein the plurality of advertisement media files comprises at least one video media file.

94. The system of claim 89 wherein the plurality of advertisement media files comprises at least one audio media file.
